(19) United States
(12) Patent Application Publication
(10) Pub. No.: US 2024/0378886 A1
(43) Pub. Date: Nov. 14, 2024

(54) WEARABLE DEVICE, INFORMATION PROCESSING METHOD, AND NON-TRANSITORY COMPUTER READABLE RECORDING MEDIUM STORING INFORMATION PROCESSING PROGRAM

(71) Applicant: Panasonic Intellectual Property Corporation of America, Torrance, CA (US)

(72) Inventors: Kotaro SAKATA, Osaka (JP); Satoshi MATSUI, Kyoto (JP); Kenta MURAKAMI, Osaka (JP); Naomi TOMIYAMA, Kyoto (JP); Tetsuji FUCHIKAMI, Osaka (JP)

(21) Appl. No.: 18/780,921

(22) Filed: Jul. 23, 2024

Related U.S. Application Data
(63) Continuation of application No. PCT/JP2022/040526, filed on Oct. 28, 2022.

(30) Foreign Application Priority Data
Jan. 28, 2022 (JP) 2022-011930

(51) Int. Cl. G06V 20/20; G06Q 10/08; G06V 40/10; G06V 40/20

(52) U.S. Cl. CPC G06V 20/20; G06Q 10/08; G06V 40/10; G06V 40/20

(57) ABSTRACT

Smartglasses include: a camera; a control part; and a communication part. The camera photographs the visual field of a user. The control part acquires an image photographed by the camera, recognizes, through an image recognition process, a package and a hand of the user from the acquired image, determines the motion state of the user with respect to the package based on the positional relationship between the recognized package and hand, and recognizes, through the image recognition process, a package ID for identifying the package from the acquired image. The communication part receives, from a delivery management server, delivery information regarding the package corresponding to the recognized package ID and motion state information indicating the determined motion state. The control part generates alert information to be presented to the user based on the delivery information, and outputs the generated alert information.

### FIELD OF INVENTION

The present disclosure relates to a technique for supporting carrying work of a package by a user.

### BACKGROUND ART

For example, in Patent Literature 1, an information processing system that supports picking work of an article by a worker acquires article information related to identification of an article of a picking target, acquires a proficiency level of the worker, determines whether or not a condition related to the article of the picking target is met based on the acquired article information, determines attention information of the picking work that calls attention to the worker, the attention information corresponding to the acquired proficiency level of the worker, and controls to output the determined attention information in a case of determining that the condition is met.

However, in the conventional technique described above, attention information is not necessarily presented in accordance with the motion state of the worker with respect to the package, and further improvement is required.

Patent Literature 1: JP 6696057 B2

### SUMMARY OF THE INVENTION

The present disclosure has been made to solve the above problem, and an object of the present invention is to provide a technique that can reduce delivery errors and delivery loss and improving delivery efficiency.

A wearable device according to the present disclosure is a wearable device worn on a head of a user, the wearable device including: a camera; a control part; and a communication part, in which the camera photographs a user's visual field, the control part acquires an image photographed by the camera, recognizes, through an image recognition process, a package and a hand of the user from the image having been acquired, determines a motion state of the user with respect to the package based on a positional relationship between the package and the hand having been recognized, and recognizes, through an image recognition process, a package ID for identifying the package from the image having been acquired, the communication part transmits, to a delivery management server, the package ID having been recognized and motion state information indicating the motion state having been determined, and receives, from the delivery management server, delivery information regarding the package corresponding to the package ID and the motion state information, and the control part generates alert information to be presented to the user based on the delivery information having been received, and outputs the alert information having been generated.

According to the present disclosure, since alert information is presented according to the motion state of the user with respect to the package, it is possible to reduce delivery errors and delivery loss and to improve delivery efficiency.

### BRIEF DESCRIPTION OF THE DRAWINGS

FIG. 1 is a view illustrating an example of a configuration of a delivery system in an embodiment of the present disclosure.

FIG. 2 is a view illustrating an appearance of smartglasses in the embodiment of the present disclosure.

FIG. 3 is a view illustrating an example of package information in the present embodiment.

FIG. 4 is a first flowchart for describing an alert information presentation process by the smartglasses in the embodiment of the present disclosure.

FIG. 5 is a second flowchart for describing the alert information presentation process by the smartglasses in the embodiment of the present disclosure.

FIG. 6 is a view illustrating an example of an image photographed by a camera in a first motion state.

FIG. 7 is a view illustrating an example of an image photographed by the camera in a second motion state.

FIG. 8 is a view illustrating an example of an image photographed by the camera in a third motion state.

FIG. 9 is a view for describing a process of recognizing a package ID from an image photographed by the camera in the first motion state.

FIG. 10 is a view for describing a process of recognizing a package ID from an image photographed by the camera in the second motion state.

FIG. 11 is a view for describing a process of recognizing a package ID from an image photographed by the camera in the third motion state.

FIG. 12 is a view illustrating an example of alert information displayed on a display part of the smartglasses in the first motion state.

FIG. 13 is a view illustrating an example of alert information displayed on the display part of the smartglasses in the second motion state.

FIG. 14 is a view illustrating an example of alert information displayed on the display part of the smartglasses in the third motion state.

FIG. 15 is a view illustrating another example of alert information displayed on the display part of the smartglasses in the second motion state.

FIG. 16 is a view illustrating an example of weight threshold information in a modification of the present embodiment.

### DETAILED DESCRIPTION

### Knowledge Underlying Present Disclosure

In the above-described conventional technique, a photographed image in a line-of-sight direction of a worker is acquired by a camera provided in the smartglasses, a product code of a package is acquired from the acquired photographed image, and attention information corresponding to the product code is displayed on a display provided in the smartglasses. Therefore, the attention information is determined in advance for each product. Therefore, in the conventional technique, the attention information is not necessarily displayed depending on the motion state of the worker with respect to the package.

In order to solve the above problem, a technique below is disclosed.

(1) A wearable device according to one aspect of the present disclosure is a wearable device worn on a head of a user, the wearable device including: a camera; a control part; and a communication part, in which the camera photographs a user's visual field, the control part acquires an image photographed by the camera, recognizes, through an image recognition process, a package and a hand of the user from the image having been acquired, determines a motion state of the user with respect to the package based on a positional relationship between the package and the hand having been recognized, and recognizes, through an image recognition process, a package ID for identifying the package from the image having been acquired, the communication part transmits, to a delivery management server, the package ID having been recognized and motion state information indicating the motion state having been determined, and receives, from the delivery management server, delivery information regarding the package corresponding to the package ID and the motion state information, and the control part generates alert information to be presented to the user based on the delivery information having been received, and outputs the alert information having been generated.

According to this configuration, the package and the hand of the user are recognized through the image recognition process from the image indicating the user's visual field photographed by the camera, and the motion state of the user with respect to the package is determined based on the positional relationship between the package and the hand having been recognized. Then, alert information to be presented to the user is generated based on the delivery information regarding the package corresponding to the package ID for identifying the package and the motion state information indicating the motion state having been determined, and the generated alert information is output.

Therefore, since alert information is presented according to the motion state of the user with respect to the package, it is possible to reduce delivery errors and delivery loss and to improve delivery efficiency.

(2) In the wearable device according to (1), the motion state may include a first motion state in which the user is viewing the package at a place a predetermined distance away from the package, a second motion state immediately before the user holds the package, and a third motion state in which the user is carrying the package, and the control part may determine that the motion state is the first motion state in a case of recognizing the package and not recognizing both hands of the user, may determine that the motion state is the second motion state in a case of recognizing at least one of a right hand and a left hand of the user, and when the right hand and the left hand of the user having been recognized are not positioned at a right end and a left end of the package having been recognized, and may determine that the motion state is the third motion state in a case of recognizing at least one of the right hand and the left hand of the user, and when the right hand and the left hand of the user having been recognized are positioned at a right end and a left end of the package having been recognized.

According to this configuration, in a case where the package is recognized and the both hands of the user are not recognized, it is possible to present alert information corresponding to the first motion state in which the user is viewing the package at a place a predetermined distance away from the package. In a case where at least one of the right hand and the left hand of the user is recognized and the recognized right hand and left hand of the user are not positioned at the right end and the left end of the recognized package, it is possible to present alert information corresponding to the second motion state immediately before the user holds the package. Furthermore, in a case where at least one of the right hand and the left hand of the user is recognized and the recognized right hand and left hand of the user are positioned at the right end and the left end of the recognized package, it is possible to present alert information corresponding to the third motion state in which the user is carrying the package.

(3) In the wearable device according to (2), the package may be placed on a shelf divided for each delivery area, the delivery information may include a destination of the package, and the control part may recognize, through an image recognition process, a delivery area corresponding to a shelf on which the package is placed from the image having been acquired in a case of determining that the motion state is the first motion state, and may generate the alert information in a case where the destination included in the delivery information having been received is not included in the delivery area having been recognized.

According to this configuration, in a case where the motion state is determined to be the first motion state and the destination of the package having been recognized is not included in the delivery area corresponding to the shelf on which the package is placed, the alert information is presented, and therefore the user can learn that the package is placed on the shelf corresponding to a wrong delivery area.

(4) In the wearable device according to (2), the delivery information may include weight of the package or valuable article information indicating whether or not the package is a valuable article, and the control part may generate the alert information in a case of determining that the motion state is the second motion state, and the weight included in the delivery information having been received is equal to or greater than a threshold or the valuable article information included in the delivery information having been received indicates that the package is a valuable article.

According to this configuration, the alert information is presented in a case where the motion state is determined to be the second motion state and the weight of the package having been recognized is equal to or greater than the threshold. Therefore, the user can learn that the weight of the package the user is about to hold is equal to or greater than the threshold. In a case where the motion state is determined to be the second motion state and the recognized package is a valuable article, alert information is presented. Therefore, the user can learn that the package the user is about to hold is a valuable article.

(5) In the wearable device according to (4), the communication part may transmit the package ID, the motion state information, and attribute information indicating an attribute of the user to the delivery management server, and the delivery information may include the threshold varying depending on weight of the package and the attribute.

For example, the weight of the package the user can carry varies depending on the attribute of the user such as age or sex. According to this configuration, since the weight of the package having been recognized is compared with the threshold varying depending on the attribute of the user, it is possible to present alert information in accordance with the attribute of the user.

(6) In the wearable device according to (2), the delivery information may include weight of the package or valuable article information indicating whether or not the package is a valuable article, and in a case of determining that the motion state is the second motion state, the control part may generate, as the alert information, a heat map representing, by a color in accordance with weight of the package, a part corresponding to the package having been recognized, or may generate, as the alert information, a heat map representing, by a color in accordance with whether or not the package is a valuable article, a part corresponding to the package having been recognized.

According to this configuration, in a case where the motion state is determined to be the second motion state, the heat map representing, by a color in accordance with the weight of the package, a part corresponding to the package having been recognized is presented as the alert information. Therefore, the user can intuitively grasp the weight of the package the user is about to hold. In a case where the motion state is determined to be the second motion state, a heat map representing, by a color in accordance with whether or not the package is a valuable article, a part corresponding to the package having been recognized is presented as the alert information. Therefore, the user can intuitively grasp whether or not the package the user is about to hold is a valuable article.

(7) In the wearable device according to (2), the delivery information may include redelivery information indicating whether or not redelivery has been requested for the package or absence information indicating whether or not a recipient of the package is absent on a scheduled delivery date of the package, the delivery management server may update the redelivery information or the absence information for the package ID, and the control part may generate the alert information in a case of determining that the motion state is the third motion state, and when the redelivery information included in the delivery information having been received indicates that the redelivery has been requested or when the absence information included in the delivery information having been received indicates that the recipient is absent on the scheduled delivery date.

According to this configuration, alert information is generated in a case where the motion state is determined to be the third motion state and the redelivery information included in the delivery information indicates that redelivery has been requested or the absence information included in the delivery information indicates that the recipient is absent on the scheduled delivery date. Therefore, the alert information can be presented to the user in a case where redelivery has been requested for the package the user is carrying or in a case where the recipient of the package the user is carrying is absent on the scheduled delivery date.

(8) In the wearable device according to (2), the wearable device may further include a memory that stores the motion state having been determined, and the control part may acquire the motion state last time from the memory in a case of determining that the motion state is the second motion state, may generate the alert information in a case where the motion state last time is the first motion state, and needs not generate the alert information in a case where the motion state last time is the third motion state.

According to this configuration, the determined motion state is stored in the memory. In a case where the motion state is determined to be the second motion state, the motion state last time is acquired from the memory. Then, the alert information is generated in a case where the motion state last time is the first motion state, and the alert information is not generated in a case where the motion state last time is the third motion state.

In a case where the motion state of the user transitions from the first motion state to the second motion state, the user is in a state of being about to hold the package. In this case, by outputting the alert information, it is possible to call attention to the user. On the other hand, in a case where the motion state of the user transitions from the third motion state to the second motion state, the user is in a state of releasing the package the user is holding. In this case, by not outputting the alert information, it is possible to prevent unnecessary alert information from being presented to the user.

(9) In the wearable device according to (2), the control part may recognize, through an image recognition process, a package ID for identifying all packages included in the image having been acquired in a case of determining that the motion state is the first motion state, and may specify one package that is a work target of the user, and may recognize, through an image recognition process, a package ID for identifying the one package having been specified from the image having been acquired in a case of determining that the motion state is the second motion state or the third motion state.

According to this configuration, in a case where the motion state of the user is the first motion state, it is possible to present the alert information for all the packages in the user's visual field. In a case where the motion state of the user is the second motion state or the third motion state, it is possible to present the alert information for the one package that is a work target of the user.

(10) In the wearable device according to any one of (1) to (9), the wearable device may further include a display part, the control part may output the alert information to the display part, and the display part may display, as augmented reality, the alert information in a user's visual field.

According to this configuration, since the alert information is output to the display part, and the alert information is displayed as augmented reality in the user's visual field by the display part, the user can confirm the alert information while viewing the package.

(11) In the wearable device according to any one of (1) to (10), the wearable device may further include a speaker, the control part may output the alert information to the speaker, and the speaker may voice-output the alert information.

According to this configuration, since the alert information is output to the speaker and the alert information is voice-output by the speaker, the user can confirm the alert information while viewing the package.

The present disclosure can be implemented not only as the wearable device having the characteristic configuration as described above but also as an information processing method for executing characteristic processing corresponding to the characteristic configuration included in the wearable device. The present disclosure can also be implemented as a computer program that causes a computer to execute characteristic processing included in the information processing method described above. Therefore, also in another aspect described below, the same effects as those of the above-described wearable device can be obtained.

(12) An information processing method according to another aspect of the present disclosure is an information processing method in a wearable device worn on a head of a user, the information processing method including: acquiring an image photographed by a camera that photographs a user's visual field; recognizing, through an image recognition process, a package and a hand of the user from the image having been acquired; determining a motion state of the user with respect to the package based on a positional relationship between the package and the hand having been recognized; recognizing, through an image recognition process, a package ID for identifying the package from the image having been acquired; transmitting, to a delivery management server, the package ID having been recognized and motion state information indicating the motion state having been determined; receiving, from the delivery management server, delivery information regarding the package corresponding to the package ID and the motion state information; generating alert information to be presented to the user based on the delivery information having been received; and outputting the alert information having been generated.

(13) An information processing program according to another aspect of the present disclosure causes a computer to function to: acquire an image photographed by a camera that photographs a user's visual field; recognize, through an image recognition process, a package and a hand of the user from the image having been acquired; determine a motion state of the user with respect to the package based on a positional relationship between the package and the hand having been recognized; recognize, through an image recognition process, a package ID for identifying the package from the image having been acquired; transmit, to a delivery management server, the package ID having been recognized and motion state information indicating the motion state having been determined; receive, from the delivery management server, delivery information regarding the package corresponding to the package ID and the motion state information; generate alert information to be presented to the user based on the delivery information having been received; and output the alert information having been generated.

(14) A non-transitory computer-readable recording medium recording an information processing program according to another aspect of the present disclosure causes a computer to function to: acquire an image photographed by a camera that photographs a user's visual field; recognize, through an image recognition process, a package and a hand of the user from the image having been acquired; determine a motion state of the user with respect to the package based on a positional relationship between the package and the hand having been recognized; recognize, through an image recognition process, a package ID for identifying the package from the image having been acquired; transmit, to a delivery management server, the package ID having been recognized and motion state information indicating the motion state having been determined; receive, from the delivery management server, delivery information regarding the package corresponding to the package ID and the motion state information; generate alert information to be presented to the user based on the delivery information having been received; and output the alert information having been generated.

An embodiment of the present disclosure will be described below with reference to the accompanying drawings. Note that the embodiment below is an example of embodiment of the present disclosure, and is not intended to limit the technical scope of the present disclosure.

### Embodiment

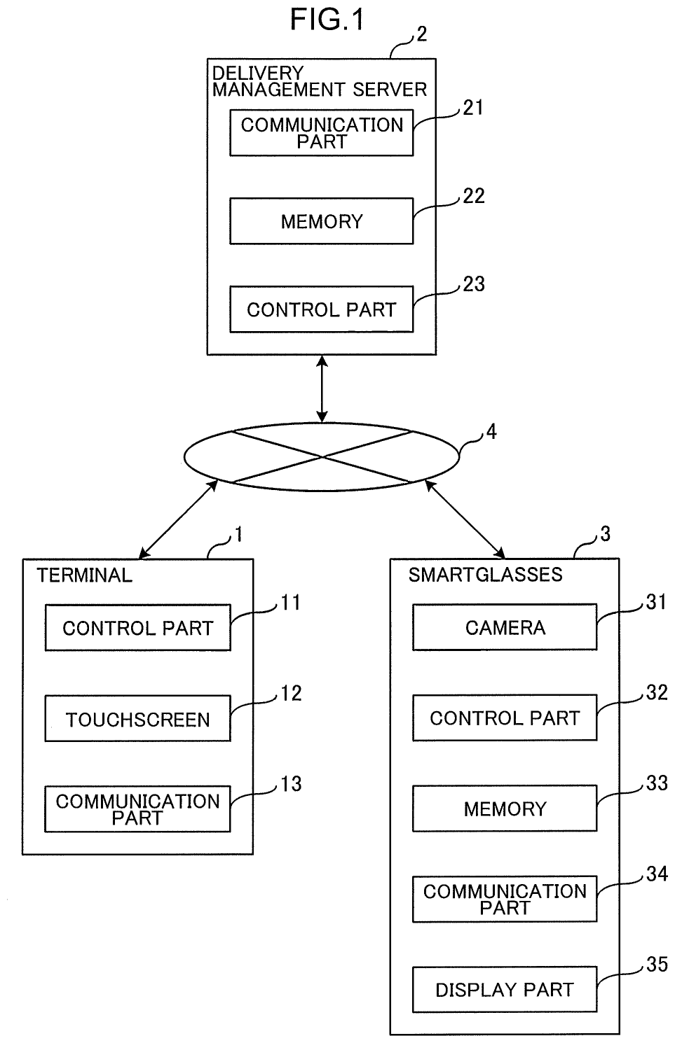

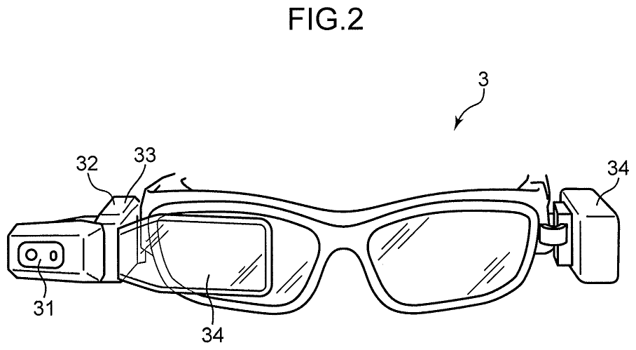

FIG. 1 is a view illustrating an example of the configuration of a delivery system in an embodiment of the present disclosure, and FIG. 2 is a view illustrating an appearance of smartglasses 3 in the embodiment of the present disclosure. The delivery system illustrated in FIG. 1 includes a terminal 1, a delivery management server 2, and the smartglasses 3.

The terminal 1 is, for example, a smartphone, a tablet computer, or a personal computer, and is used by a recipient of a package. The terminal 1 includes a control part 11, a touchscreen 12, and a communication part 13.

The control part 11 is, for example, a central processing unit (CPU), and controls the entire terminal 1. The control part 11 causes the touchscreen 12 to display a redelivery reception screen for receiving a request for redelivery of a package, and causes the touchscreen 12 to display an absence input reception screen for receiving input as to whether or not the recipient of the package is absent on a scheduled delivery date of the package.

The touchscreen 12 displays various types of information and receives input operation by the recipient. On the redelivery reception screen, the touchscreen 12 receives a request for redelivery by the recipient and receives input by the recipient of a date and time at which the redelivery is desired. The recipient inputs, to the touchscreen 12, a package ID of the package that the recipient has failed to receive, an instruction to request redelivery, and a date and time at which the redelivery is desired.

The touchscreen 12 receives input indicating that the recipient is absent on the scheduled delivery date on the absence input reception screen. In a case where the recipient is absent on the scheduled delivery date of the package and cannot receive the package, the recipient inputs, to the touchscreen 12, that the recipient is absent on the scheduled delivery date.

In a case where a request for redelivery is received by the touchscreen 12, the communication part 13 transmits, to the delivery management server 2, redelivery request information including the package ID and the redelivery desirable date and time and for requesting redelivery of the package. In a case where input indicating that the recipient is absent on the scheduled delivery date is received by the touchscreen 12, the communication part 13 transmits, to the delivery management server 2, absence notification information for notifying that the recipient is absent on the scheduled delivery date.

The delivery management server 2 manages a delivery status of the package. The delivery management server 2 manages package information regarding the package, and transmits the delivery information to the smartglasses 3 in response to a request from the smartglasses 3.

The delivery management server 2 is communicably connected to each of the terminal 1 and the smartglasses 3 via a network 4. The network 4 is the Internet, for example.

The delivery management server 2 includes a communication part 21, a memory 22, and a control part 23.

The communication part 21 receives, from the terminal 1, redelivery request information for requesting redelivery for the package. The communication part 21 receives, from the terminal 1, absence notification information for notifying that the recipient of the package is absent on the scheduled delivery date of the package. The communication part 21 receives the package ID and the motion state information from the smartglasses 3. The communication part 21 transmits, to the smartglasses 3, delivery information regarding the package corresponding to the package ID and the motion state information.

The memory 22 is a storage device that can store various types of information, such as a random access memory (RAM), a hard disk drive (HDD), a solid state drive (SSD), or a flash memory. The memory 22 stores package information regarding the package.

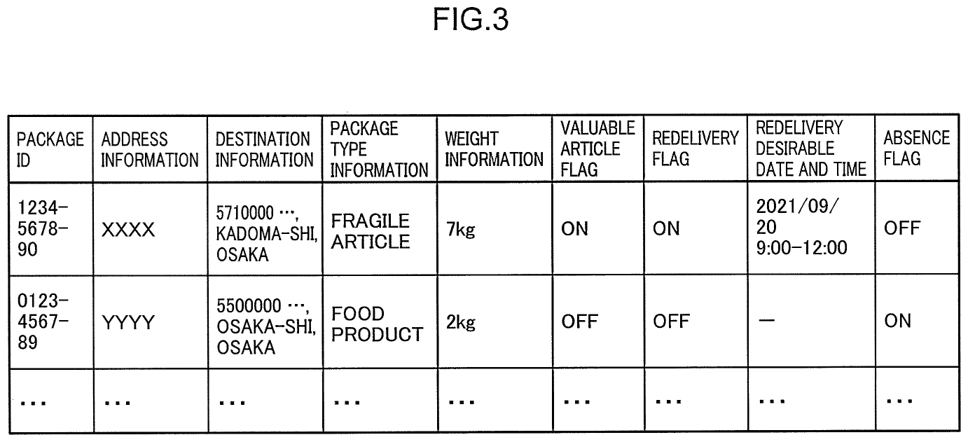

FIG. 3 is a view illustrating an example of package information in the present embodiment.

The package information illustrated in FIG. 3 includes a package ID for identifying the package, address information indicating an address of the package, destination information indicating a destination of the package, package type information indicating a type of the package, weight information indicating the weight of the package, a valuable article flag (valuable article information) indicating whether or not the package is a valuable article, a redelivery flag (redelivery information) indicating whether or not redelivery has been requested for the package, a redelivery desirable date and time indicating the date and time when the recipient desires redelivery of the package, and an absence flag (absence information) indicating whether or not the recipient of the package is absent on the scheduled delivery date of the package. The type of a package indicates content of the package such as a fragile article, a food product, or a book.

The weight information and the valuable article flag (valuable article information) are input by the requester who has requested the delivery of the package or the worker who has picked up the package. The valuable article flag being on indicates that the package is a valuable article, and the valuable article flag being off indicates that the package is not a valuable article.

The control part 23 is, for example, a CPU, and controls the entire delivery management server 2. The control part 23 updates the redelivery flag (redelivery information) or the absence flag (absence information) for the package ID. Based on the redelivery request information received by the communication part 21, the control part 23 updates the redelivery flag and the redelivery desirable date and time of the package information stored in the memory 22. The control part 23 updates the absence flag of the package information stored in the memory 22 based on the absence notification information received by the communication part 21.

In a case where redelivery has not been requested by the recipient, the control part 23 turns off the redelivery flag. In a case where redelivery request information is received and redelivery has been requested by the recipient, the control part 23 turns on the redelivery flag. In a case where the redelivery request information received from the terminal 1 includes the redelivery desirable date and time, the control part 23 updates the redelivery desirable date and time.

In a case where the recipient has not notified that the recipient is absent on the scheduled delivery date, the control part 23 turns off the absence flag. In a case where absence notification information is received, and it is notified from the recipient that the recipient is absent on the scheduled delivery date, the control part 23 turns on the absence flag.

When the package ID and the motion state information are received by the communication part 21, the control part 23 reads the delivery information corresponding to the package ID and the motion state information from the memory 22, and transmits the read delivery information to the smartglasses 3 via the communication part 21.

The smartglasses 3 are a glasses type wearable device worn on the head of the user. Here, the user is a worker who sorts or delivers a package. The user wears the smartglasses 3 and performs work.

The smartglasses 3 illustrated in FIGS. 1 and 2 include a camera 31, a control part 32, a memory 33, a communication part 34, and a display part 35.

The camera 31 photographs the user's visual field. The camera 31 is provided on the right side of a main body of the smartglasses 3, and photographs a view in front of the user wearing the smartglasses 3. An angle of view and a focal length of the camera 31 are set to be substantially the same as a user's visual field. For this reason, an image acquired by the camera 31 is substantially the same as scenery the user sees with naked eyes. The camera 31 outputs a photographed image to the control part 32.

The control part 32 acquires an image photographed by the camera 31. The control part 32 recognizes, through an image recognition process, the package and the hand of the user from the image having been acquired. The control part 32 determines the motion state of the user with respect to the package based on the positional relationship between the package and the hand having been recognized.

The motion state includes the first motion state in which the user is viewing the package at a place a predetermined distance away from the package, the second motion state immediately before the user holds the package, and the third motion state in which the user is carrying the package. At this time, in a case of recognizing the package and not recognizing both hands of the user, the control part 32 determines that the motion state is the first motion state. The control part 32 determines that the motion state is the second motion state in a case of recognizing at least one of the right hand and the left hand of the user, and when the recognized right hand and left hand of the user are not positioned at the right end and the left end of the recognized package. The control part 32 determines that the motion state is the third motion state in a case of recognizing at least one of the right hand and the left hand of the user, and when the recognized right hand and left hand of the user are positioned at the right end and the left end of the recognized package.

The control part 32 recognizes, through an image recognition process, a package ID for identifying the package from the image having been acquired. In a case of determining that the motion state is the first motion state, the control part 32 recognizes, through an image recognition process, the package ID for identifying all packages included in the image having been acquired. In a case of determining that the motion state is the second motion state or the third motion state, the control part 32 specifies one package that is a work target of the user, and recognizes, through an image recognition process, the package ID for identifying the specified one package from the image having been acquired.

At this time, in a case of determining that the motion state is the second motion state, the control part 32 specifies, as the one package that is the work target of the user, a package closest to at least one of the position of the right hand of the user having been recognized and the position of the left hand of the user having been recognized, and recognizes the package ID of the specified one package. For example, in a case of determining that the motion state is the second motion state and recognizing both hands of the user, the control part 32 may specify, as the one package that is the work target of the user, the package closest to both a tip end portion of the right hand of the user having been recognized and a tip end portion of the left hand of the user having been recognized. For example, in a case of determining that the motion state is the second motion state and recognizing any one of the right hand and the left hand of the user, the control part 32 may specify, as the one package that is the work target of the user, the package closest to the tip end portion of the right hand of the user having been recognized or the tip end portion of the left hand of the user having been recognized.

In a case of determining that the motion state is the third motion state, the control part 32 specifies, as the one package that is the work target of the user, a package between the position of the right hand of the user having been recognized and the position of the left hand of the user having been recognized, and recognizes the package ID of the specified one package.

The memory 33 is a storage device that can store various types of information such as a RAM or a flash memory, for example. The memory 33 stores various types of information.

In a case of determining that the motion state is the first motion state, the control part 32 recognizes, through an image recognition process, the delivery area corresponding to the shelf on which the package is placed from the image having been acquired. The package is placed on a shelf divided for each delivery area.

The communication part 34 transmits, to the delivery management server 2, the package ID recognized by the control part 32 and the motion state information indicating the motion state determined by the control part 32. The communication part 34 receives, from the delivery management server 2, the delivery information regarding the package corresponding to the package ID and the motion state information.

In a case where the motion state information indicating that the motion state is the first motion state is received, the control part 23 of the delivery management server 2 reads the destination information corresponding to the package ID from the package information stored in the memory 22, and generates delivery information including at least the package ID and the destination information. In a case where the motion state information indicating that the motion state is the second motion state is received, the control part 23 reads the weight information corresponding to the package ID from the package information stored in the memory 22, and generates delivery information including at least the package ID and the weight information. In a case where the motion state information indicating that the motion state is the third motion state is received, the control part 23 reads the redelivery flag (redelivery information) and the absence flag (absence information) corresponding to the package ID from the package information stored in the memory 22, and generates delivery information including at least the package ID, the redelivery flag (redelivery information), and the absence flag (absence information). The communication part 21 transmits the delivery information generated by the control part 23 to the smartglasses 3.

The control part 32 generates alert information to be presented to the user based on the delivery information received by the communication part 34.

The control part 32 generates alert information in a case of determining that the motion state is the first motion state and in a case where the destination included in the received delivery information is not included in the recognized delivery area. In this case, the control part 32 generates alert information for warning that the package is placed on a shelf corresponding to a wrong delivery area.

The control part 32 generates alert information in a case of determining that the motion state is the second motion state, and when the weight included in the received delivery information is equal to or greater than a threshold. In this case, the control part 32 generates alert information for warning that the weight of the package is equal to or greater than the threshold.

The control part 32 generates alert information in a case of determining that the motion state is the third motion state and when the redelivery flag (redelivery information) included in the delivery information received by the communication part 34 indicates that redelivery has been requested or when the absence flag (absence information) included in the delivery information received by the communication part 34 indicates that the recipient is absent on the scheduled delivery date.

In a case where the redelivery flag (redelivery information) included in the delivery information received by the communication part 34 indicates that redelivery has been requested, the control part 32 generates alert information indicating that redelivery has been requested for the recognized package. In a case where the absence flag (absence information) included in the delivery information received by the communication part 34 indicates that the recipient is absent on the scheduled delivery date, the control part 32 generates alert information indicating that the recipient is absent on the recognized scheduled delivery date of the package.

The control part 32 outputs the generated alert information. At this time, the control part 32 outputs the alert information to the display part 35.

The display part 35 is a light transmissive display, and displays alert information as augmented reality in the user's visual field. For example, the display part 35 displays alert information in front of the right eye of the user wearing the smartglasses 3.

Subsequently, the alert information presentation process by the smartglasses 3 in the embodiment of the present disclosure will be described.

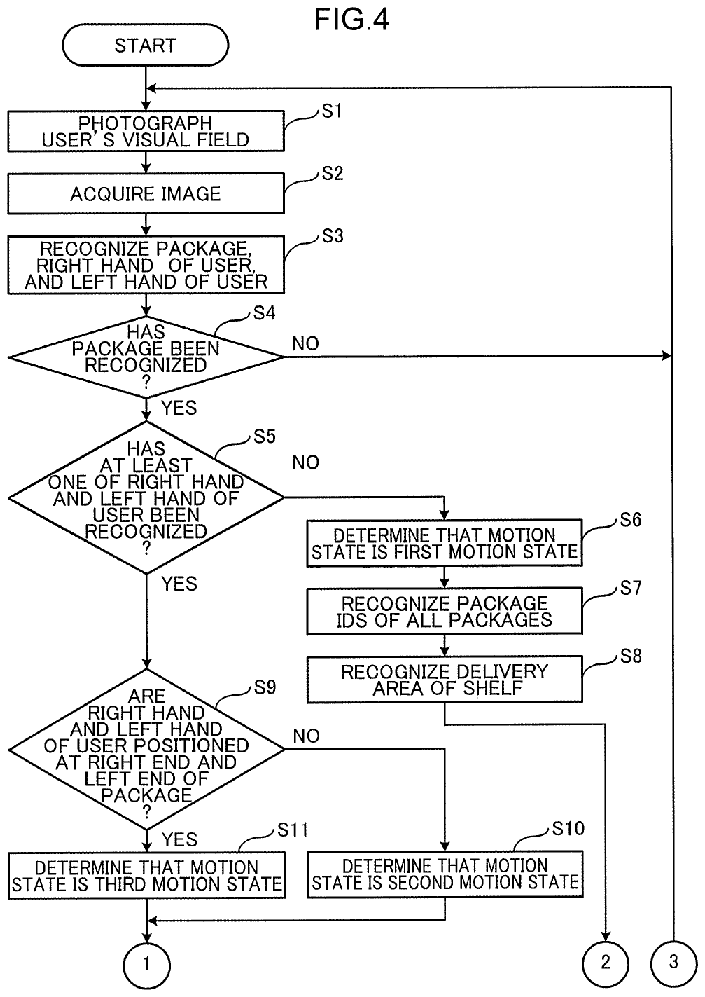

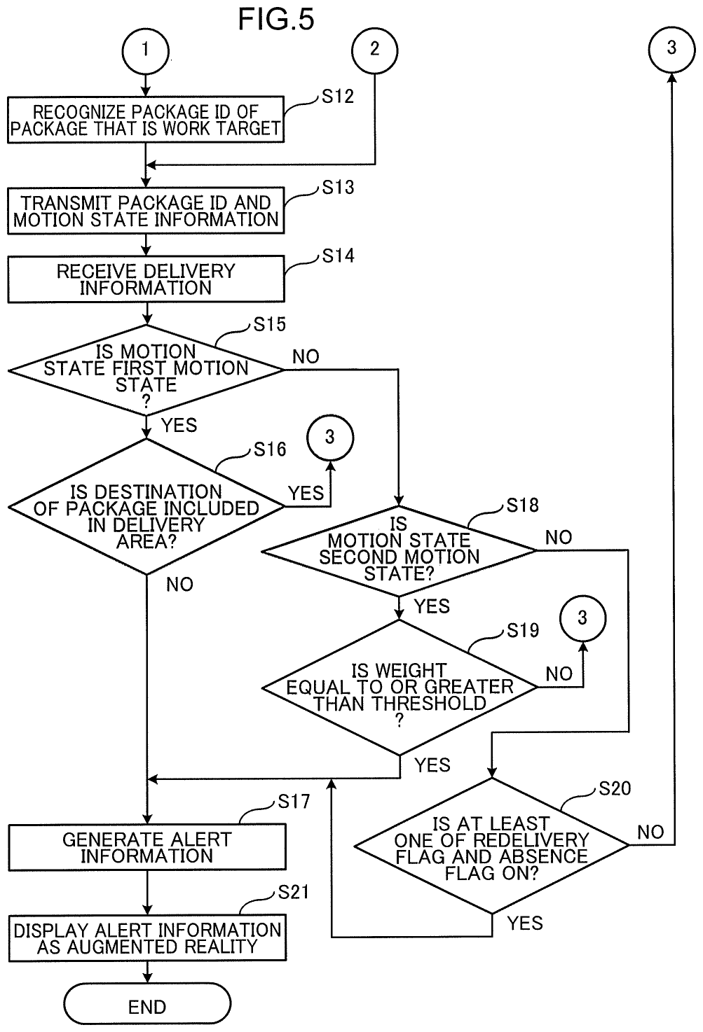

FIG. 4 is a first flowchart for describing the alert information presentation process by the smartglasses 3 in the embodiment of the present disclosure, and FIG. 5 is a second flowchart for describing the alert information presentation process by the smartglasses 3 in the embodiment of the present disclosure.

First, in step S1, the camera 31 photographs a user's visual field. During work of the user, the camera 31 continuously photographs a user's visual field.

Next, in step S2, the control part 32 acquires, from the camera 31, an image obtained by the camera 31 photographing a user's visual field.

Next, in step S3, the control part 32 recognizes, through an image recognition process, the package, the left hand of the user, and the right hand of the user from the image having been acquired.

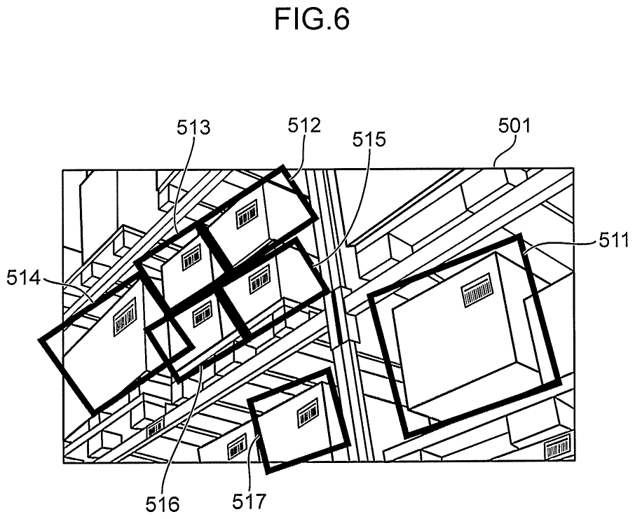

FIG. 6 is a view illustrating an example of an image photographed by the camera 31 in the first motion state.

The package is placed on a shelf divided for each delivery area. In the first motion state, the user is viewing the package at a place a predetermined distance away from the package. At this time, both hands of the user are not in the user's visual field, and only the package is in the user's visual field. That is, in a case where only the package appears in an image and both hands of the user do not appear in the image, it can be determined that the motion state of the user is the first motion state in which the user is viewing the package at a place a predetermined distance away from the package.

The control part 32 recognizes the package, the left hand of the user, and the right hand of the user from the image photographed by the camera 31. In FIG. 6, the plurality of packages recognized from an image 501 are represented by rectangular frame lines 511 to 517. Since both hands of the user do not appear in the image 501, the plurality of packages are recognized, and the right hand and the left hand of the user are not recognized.

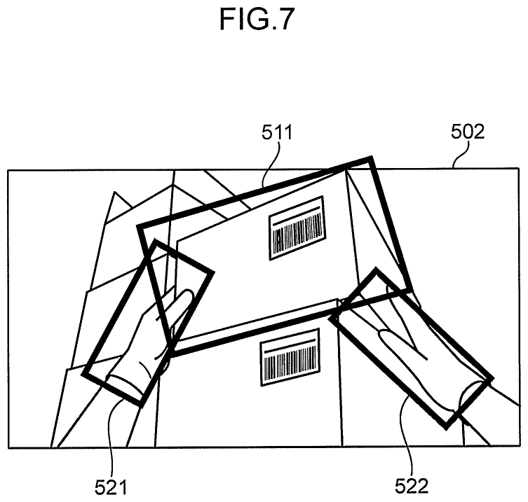

FIG. 7 is a view illustrating an example of an image photographed by the camera 31 in the second motion state.

In the second motion state, the user is stretching the hand toward the package in an attempt to hold the package. At this time, not only the package but also at least one of the right hand and the left hand of the user is in the user's visual field. However, since the user does not hold the package, the right hand and the left hand of the user are not positioned at the right end and the left end of the package. That is, in a case where the package and at least one of the right hand and the left hand of the user appear in the image, and the right hand and the left hand of the user are not positioned at the right end and the left end of the package, it can be determined that the motion state of the user is the second motion state immediately before the user holds the package.

The control part 32 recognizes the package that is the work target of the user, the left hand of the user, and the right hand of the user from an image photographed by the camera 31. In FIG. 7, the package recognized from an image 502 is represented by a rectangular frame line 511, the left hand of the user recognized from the image 502 is represented by a rectangular frame line 521, and the right hand of the user recognized from the image 502 is represented by a rectangular frame line 522. The frame line 521 corresponding to the left hand of the user is positioned at the left end of the frame line 511 corresponding to the package, but the frame line 522 corresponding to the right hand of the user is not positioned at the right end of the frame line 511 corresponding to the package.

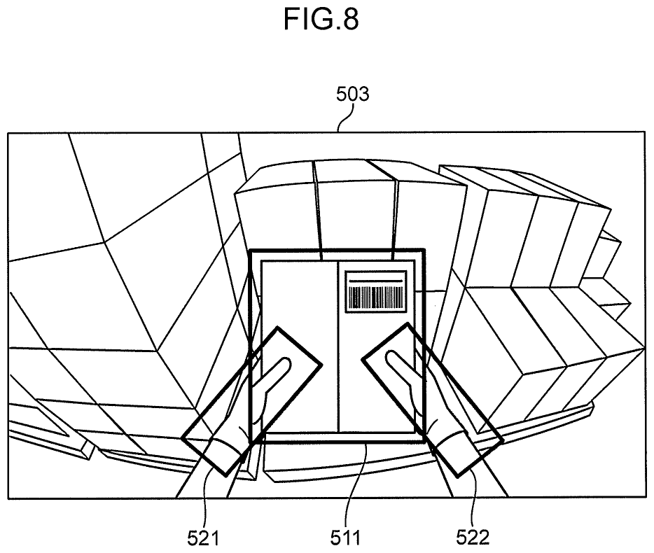

FIG. 8 is a view illustrating an example of an image photographed by the camera 31 in the third motion state.

In the third motion state, the user is carrying the package. When carrying a package, the user grips the package with both hands. At this time, the thumb of the left hand and the thumb of the right hand of the user are placed on an upper surface of the package, and the package is between the left hand and the right hand of the user. The user's visual field includes not only the package but also both the right hand and the left hand of the user, and the right hand and the left hand of the user are positioned at the right end and the left end of the package. That is, in a case where the package and at least one of the right hand and the left hand of the user appear in the image, and the right hand and the left hand of the user are positioned at the right end and the left end of the package, it can be determined that the motion state of the user is the third motion state in which the user carries the package.

The control part 32 recognizes the package that is the work target of the user, the left hand of the user, and the right hand of the user from an image photographed by the camera 31. In FIG. 8, the package recognized from an image 503 is represented by the rectangular frame line 511, the left hand of the user recognized from the image 503 is represented by the rectangular frame line 521, and the right hand of the user recognized from the image 503 is represented by the rectangular frame line 522. The frame line 521 corresponding to the left hand of the user is positioned at the left end of the frame line 511 corresponding to the package, and the frame line 522 corresponding to the right hand of the user is positioned at the right end of the frame line 511 corresponding to the package.

Note that the control part 32 performs an image recognition process using an image recognition model machine-learned so as to recognize each of the package, the left hand of the user, and the right hand of the user from the image. The control part 32 inputs an image photographed by the camera 31 to the machine-learned image recognition model, and acquires a recognition result from the image recognition model. The recognition result indicates the position of the package on the image, the position of the left hand of the user, and the position of the right hand of the user.

Note that examples of machine learning include supervised learning in which a relationship between input and output is learned using training data in which a label (output information) is assigned to input information, unsupervised learning in which a data structure is constructed only by unlabeled input, semi-supervised learning in which both labeled and unlabeled input are handled, and reinforcement learning in which an action that maximizes a reward is learned by trial and error. Specific methods of machine learning include a neural network (including deep learning using a multilayer neural network), genetic programming, a decision tree, a Bayesian network, and a support vector machine (SVM). In machine learning of an image recognition model, any of the specific examples described above may be used.

The control part 32 may recognize, through pattern matching, the package, the left hand of the user, and the right hand of the user from an image.

Returning to FIG. 4, next, in step S4, the control part 32 determines whether or not the package has been recognized from the image. Here, when it is determined that the package has not been recognized from the image (NO in step S4), the process returns to step S1.

On the other hand, when it is determined that the package has been recognized from the image (YES in step S4), the control part 32 determines in step S5 whether or not at least one of the right hand and the left hand of the user has been recognized from the image. In a case where it is determined that at least one of the right hand and the left hand of the user has not been recognized from the image, that is, in a case where it is determined that both the right hand and the left hand of the user have not been recognized from the image (NO in step S5), the control part 32 determines in step S6 that the motion state is the first motion state. In the image 501 illustrated in FIG. 6, since only the package is recognized and the right hand and the left hand of the user are not recognized, the motion state is determined to be the first motion state.

Next, in step S7, the control part 32 recognizes the package IDs of all the packages in the image through an image recognition process.

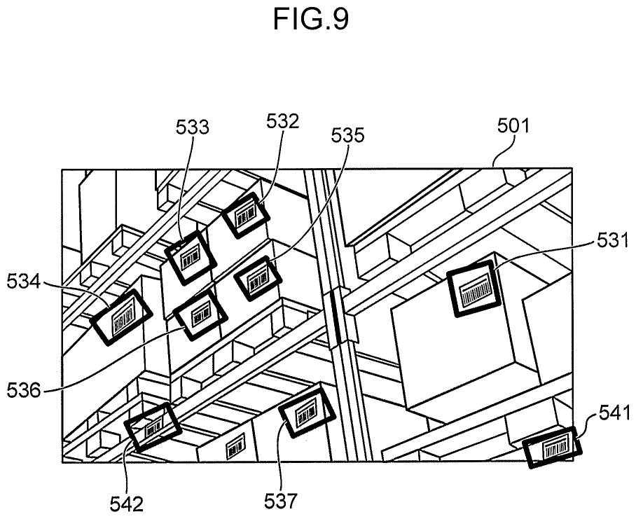

FIG. 9 is a view for describing the process of recognizing the package ID from an image photographed by the camera 31 in the first motion state.

The package is placed so that the front surface can be seen by the user. A barcode indicating the package ID is affixed to the front surface of the package. The control part 32 recognizes the package ID by recognizing the barcodes of all the packages from the image photographed by the camera 31 and reading the package ID from the recognized barcode. In FIG. 9, the barcode indicating the package ID recognized from the image 501 is represented by rectangular frame lines 531 to 537. In a case of recognizing a plurality of packages from the image, the control part 32 recognizes the package ID of each of the plurality of packages.

Note that, in the present embodiment, the package ID is indicated by a barcode, but the present disclosure is not particularly limited to this, and the package ID may be indicated by a two-dimensional code. In this case, the control part 32 may recognize the package ID by recognizing a two-dimensional code from an image photographed by the camera 31 and reading the package ID from the recognized two-dimensional code.

Next, in step S8, the control part 32 recognizes, through an image recognition process, the delivery area corresponding to the shelf in the image. A barcode indicating the delivery area of the placed package is affixed to the shelf. The control part 32 recognizes the delivery area by recognizing the barcodes of all the shelves from the image photographed by the camera 31 and reading the delivery area from the recognized barcodes. In FIG. 9, a barcode indicating the delivery area recognized from the image 501 is represented by rectangular frame lines 541 and 542. In a case where a plurality of barcodes indicating a plurality of delivery areas are affixed to the shelf, the control part 32 recognizes the plurality of delivery areas from the image.

On the other hand, in a case where it is determined that at least one of the right hand and the left hand of the user is recognized from the image (YES in step S5), the control part 32 determines in step S9 whether or not the right hand and the left hand of the user are positioned at the right end and the left end of the package.

Here, in a case where it is determined that the right hand and the left hand of the user are not positioned at the right end and the left end of the package (NO in step $9), the control part 32 determines in step S10 that the motion state is the second motion state. In the image 502 illustrated in FIG. 7, the package and the right hand and the left hand of the user are recognized, but since the right hand and the left hand of the user are not positioned at the right end and the left end of the package, the motion state is determined to be the second motion state.

On the other hand, in a case where it is determined that the right hand and the left hand of the user are positioned at the right end and the left end of the package (YES in step S9), the control part 32 determines in step S11 that the motion state is the third motion state. In the image 503 illustrated in FIG. 8, since the package and the right hand and the left hand of the user are recognized, and the right hand and the left hand of the user are positioned at the right end and the left end of the package, the motion state is determined to be the third motion state.

Next, in step S12, the control part 32 recognizes, through an image recognition process, the package ID of the package that is the work target of the user.

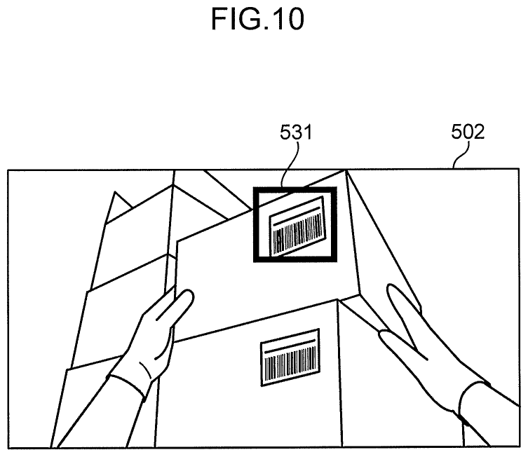

FIG. 10 is a view for describing the process of recognizing the package ID from an image photographed by the camera 31 in the second motion state.

A barcode indicating the package ID is affixed to the front surface of the package. The control part 32 specifies, from the image photographed by the camera 31, a package that the user is about to hold, that is, the package that is the work target. Then, the control part 32 recognizes the package ID by recognizing the barcode of the specified package and reading the package ID from the recognized barcode. In FIG. 10, a barcode indicating the package ID recognized from the image 502 is represented by the rectangular frame line 531.

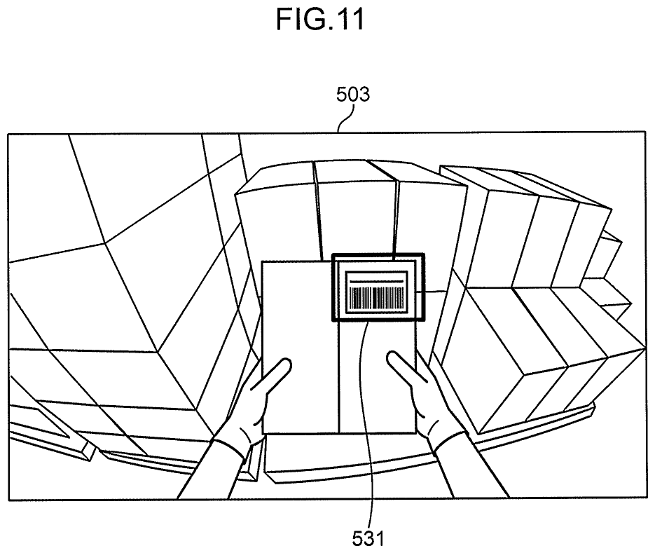

FIG. 11 is a view for describing the process of recognizing the package ID from an image photographed by the camera 31 in the third motion state.

A barcode indicating the package ID is affixed also to the upper surface of the package. The control part 32 specifies, from the image photographed by the camera 31, a package that the user is carrying, that is, the package that is the work target. Then, the control part 32 recognizes the package ID by recognizing the barcode of the specified package and reading the package ID from the recognized barcode. In FIG. 11, a barcode indicating the package ID recognized from the image 503 is represented by the rectangular frame line 531.

Returning to FIG. 5, next, in step S13, the communication part 34 transmits, to the delivery management server 2, the package ID recognized by the control part 32 and the motion state information indicating the motion state determined by the control part 32. The communication part 21 of the delivery management server 2 receives the package ID and the motion state information transmitted by the smartglasses 3. The control part 23 of the delivery management server 2 generates delivery information corresponding to the package ID and the motion state information received by the communication part 21 from the package information stored in the memory 22. The communication part 21 of the delivery management server 2 transmits, to the smartglasses 3, the delivery information generated by the control part 23.

At this time, in a case where the motion state information indicates the first motion state, the control part 23 reads the destination information corresponding to the package ID from the package information stored in the memory 22, and generates delivery information including at least the package ID and the destination information. In a case where the motion state information indicates the second motion state, the control part 23 reads weight information corresponding to the package ID from the package information stored in the memory 22, and generates delivery information including at least the package ID and the weight information. In a case where the motion state information indicates the third motion state, the control part 23 reads a redelivery flag (redelivery information) and an absence flag (absence information) corresponding to the package ID from the package information stored in the memory 22, and generates delivery information including at least the package ID, the redelivery flag (redelivery information), and the absence flag (absence information).

Next, in step S14, the communication part 34 receives the delivery information transmitted by the delivery management server 2.

Next, in step S15, the control part 32 determines whether or not the motion state is the first motion state. Here, in a case where the motion state is determined to be the first motion state (YES in step S15), the control part 32 determines in step S16 whether or not the destination of the package included in the delivery information received by the communication part 34 is included in the recognized delivery area.

Note that in a case of recognizing a plurality of packages, the control part 32 determines whether or not the destination of each of the plurality of packages is included in the delivery area corresponding to the shelf on which each of the plurality of packages is placed. In FIG. 9, the frame line 541 below the frame line 531 indicating the package ID indicates the delivery area of the package specified by the package ID in the frame line 531, and the frame line 542 below the frame lines 532 to 536 indicating the package ID indicates the delivery area of the package specified by the package ID in the frame lines 532 to 536. The control part 32 determines whether or not the destination of the package corresponding to the package ID specified by the barcode in the frame line 531 is included in the delivery area specified by the barcode in the frame line 541 below the frame line 531. The control part 32 determines whether or not the destination of each package corresponding to the package ID specified by each barcode in the frame lines 532 to 536 is included in the delivery area specified by the barcode in the frame line 542 below the frame lines 532 to 536.

Here, in a case where it is determined that the destination of the package is included in the delivery area (YES in step S16), the process returns to step S1. In this case, since the package is placed on the shelf corresponding to the correct delivery area, the alert information is not output.

On the other hand, in a case where it is determined that the destination of the package is not included in the delivery area (NO in step S16), the control part 32 generates in step S17 alert information for warning that the package is placed on a shelf corresponding to a wrong delivery area.

Note that in a case of recognizing a plurality of packages from the image, the control part 32 determines, in the determination the process of step S16, whether or not all destinations of the plurality of packages are included in the delivery area. In a case where the destinations of all the packages of the plurality of packages are included in the delivery area, the process returns to step S1. In a case where the destination of at least one package among the plurality of packages is not included in the delivery area, the process proceeds to step S17.

In a case where it is determined that the motion state is not the first motion state (NO in step S15), the control part 32 determines in step S18 whether or not the motion state is the second motion state. Here, in a case where the motion state is determined to be the second motion state (YES in step S18), the control part 32 determines in step S19 whether or not the weight included in the delivery information received by the communication part 34 is equal to or greater than a threshold. Note that the threshold is stored in the memory 33 in advance.

Here, in a case where it is determined that the weight is not equal to or greater than the threshold (NO in step S19), the process returns to step S1. In this case, since the weight of the package is lighter than the threshold, the alert information is not output.

On the other hand, in a case where it is determined that the weight is equal to or greater than the threshold (YES in step S19), the control part 32 generates, in step S17, alert information for warning that the weight of the package is equal to or greater than the threshold.

In a case where it is determined that the motion state is not the second motion state, that is, in a case where the motion state is determined to be the third motion state (NO in step S18), the control part 32 determines in step S20 whether or not at least one of the redelivery flag and the absence flag included in the delivery information received by the communication part 34 is on. Here, in a case where it is determined that both the redelivery flag and the absence flag are off (NO in step S20), the process returns to step S1. In this case, since the recipient has not requested redelivery of the package or the recipient has not notified that the recipient is absent on the scheduled delivery date of the package, the alert information is not output.

On the other hand, in a case where it is determined that at least one of the redelivery flag and the absence flag is on (YES in step S20), the control part 32 generates alert information in step S17. At this time, in a case where it is determined that the redelivery flag is on, the control part 32 generates alert information indicating that redelivery has been requested for the package being carried by the user. In a case where it is determined that the absence flag is on, the control part 32 generates alert information indicating that the recipient is absent on the scheduled delivery date of the package being carried by the user. Note that in a case where it is determined that both the redelivery flag and the absence flag are on, the control part 32 may generate both alert information indicating that redelivery has been requested for the package being carried by the user and alert information indicating that the recipient is absent on the scheduled delivery date of the package being carried by the user.

Next, in step S21, the display part 35 displays, as augmented reality, the alert information in the user's visual field.

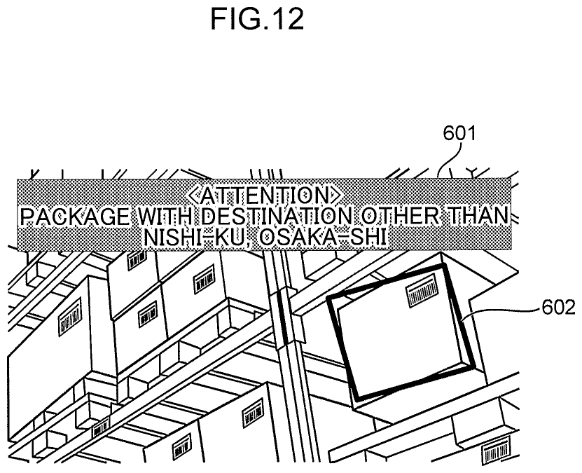

FIG. 12 is a view illustrating an example of alert information displayed on the display part 35 of the smartglasses 3 in the first motion state.

Alert information 601 illustrated in FIG. 12 indicates, by text, that the package is placed on a shelf corresponding to a wrong delivery area. A rectangular frame line 602 indicates a package placed on a shelf corresponding to a wrong delivery area among the plurality of recognized packages. The alert information 601 and the frame line 602 are displayed as augmented reality in the real environment that the user is viewing. Therefore, by viewing the alert information 601, the user can learn that the package is placed on the shelf corresponding to a wrong delivery area.

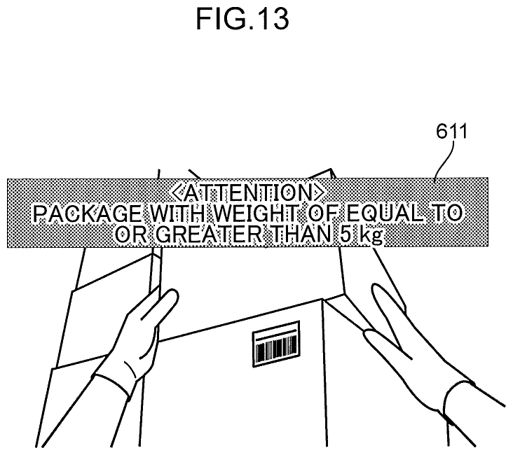

FIG. 13 is a view illustrating an example of alert information displayed on the display part 35 of the smartglasses 3 in the second motion state.

Alert information 611 illustrated in FIG. 13 indicates, by text, that the weight of the package of the work target is equal to or greater than the threshold. The threshold is, for example, 5 kg. The alert information 611 is displayed as augmented reality in the real environment that the user is viewing. Therefore, the user can learn that the weight of the package the user is about to hold is equal to or greater than the threshold by viewing the alert information 611.

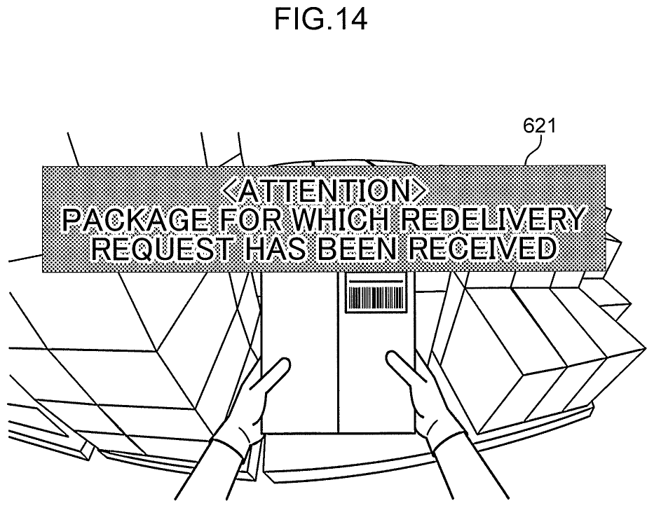

FIG. 14 is a view illustrating an example of alert information displayed on the display part 35 of the smartglasses 3 in the third motion state.

Alert information 621 illustrated in FIG. 14 indicates, by text, that redelivery has been requested for the package being carried by the user. The alert information 621 is displayed as augmented reality in the real environment that the user is viewing. Therefore, by viewing the alert information 621, the user can learn that attention is necessary for the package that the user himself is carrying.

In this manner, the package and the hand of the user are recognized through an image recognition process from the image indicating the user's visual field photographed by the camera 31, and the motion state of the user with respect to the package is determined based on the positional relationship between the package and the hand having been recognized. Then, alert information to be presented to the user is generated based on the delivery information regarding the package corresponding to the package ID for identifying the package and the motion state information indicating the motion state having been determined, and the generated alert information is output.

Therefore, since alert information is presented according to the motion state of the user with respect to the package, it is possible to reduce delivery errors and delivery loss and to improve delivery efficiency.

Note that in a modification of the present embodiment, in a case of determining that the motion state is the second motion state, the control part 32 may generate, as the alert information, a heat map representing, by a color in accordance with the weight of the package, a part corresponding to the package having been recognized.

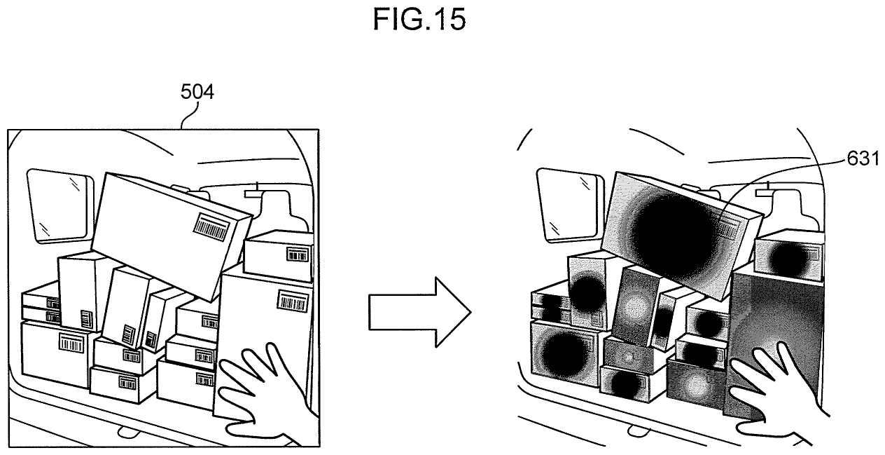

FIG. 15 is a view illustrating another example of the alert information displayed on the display part 35 of the smartglasses 3 in the second motion state.

The control part 32 recognizes a plurality of packages and the right hand of the user from an image 504 illustrated in FIG. 15. The control part 32 determines that the motion state of the user is the second motion state immediately before the user holds the package, and recognizes each package ID of the plurality of packages included in the image 504. The communication part 34 transmits the plurality of package IDs and the motion state information to the delivery management server 2, and receives the delivery information corresponding to each of the plurality of package IDs from the delivery management server 2. The delivery information includes the weight of the package. Then, the control part 32 generates, as alert information 631, a heat map representing, by a color in accordance with the weight of the package, a part corresponding to the package having been recognized. The alert information 631 illustrated in FIG. 15 is a heat map in which a part corresponding to a package having a weight of 20 kg or more is indicated in red, a part corresponding to a package having a weight of 15 kg or more is indicated in yellow, a part corresponding to a package having a weight of 10 kg or more is indicated in yellowish green, a part corresponding to a package having a weight of 5 kg or more is indicated in green, and a part corresponding to a package having a weight of less than 5 kg is indicated in blue. The alert information 631 is displayed as augmented reality in the real environment that the user is viewing. Since the weight of the package is expressed by color gradation, the user can intuitively grasp the weight of the package the user is about to hold by viewing the alert information 631.

In the present embodiment, the delivery information includes the weight of the package, and the control part 32 generates the alert information in a case of determining that the motion state is the second motion state and when the weight included in the received delivery information is equal to or greater than a threshold. However, the present disclosure is not particularly limited to this. The delivery information may include valuable article information indicating whether or not the package is a valuable article. In this case, in a case where the motion state information indicating that the motion state is the second motion state is received, the control part 23 of the delivery management server 2 may read the valuable article flag (valuable article information) corresponding to the package ID from the package information stored in the memory 22, and generate delivery information including at least the package ID and the valuable article flag (valuable article information). Then, the communication part 21 transmits the delivery information generated by the control part 23 to the smartglasses 3. In a case where the valuable article flag (valuable article information) included in the received delivery information indicates that the package is a valuable article, the control part 32 may generate alert information. In a case where the valuable article flag is on, the control part 32 may generate alert information indicating that the package that the user is about to hold is a valuable article.

Note that the control part 32 may generate, as the alert information, a heat map representing a part corresponding to the recognized package by a color in accordance with whether or not the package is a valuable article. For example, the control part 32 may generate, as the alert information, a heat map in which a part corresponding to a package that is a valuable article is indicated in red and a part corresponding to a package that is not a valuable article is indicated in blue.

In the present embodiment, the threshold to be compared with the weight is stored in the memory 33 in advance, but the present disclosure is not particularly limited to this, and may vary depending on the attribute of the user. In this case, the communication part 34 transmits, to the delivery management server 2., the package ID, the motion state information, and the attribute information indicating the attribute of the user. The attribute information includes age and sex and is stored in the memory 33. The communication part 21 of the delivery management server 2 receives the package ID, the motion state information, and the attribute information transmitted by the smartglasses 3. The memory 22 of the delivery management server 2 stores in advance weight threshold information in which attribute information and a threshold of weight are associated with each other.

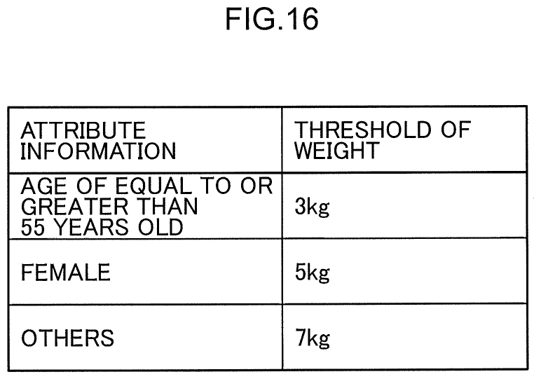

FIG. 16 is a view illustrating an example of weight threshold information according to a modification of the present embodiment.

As illustrated in FIG. 16, a threshold of weight is associated with attribute information. For example, a threshold of 3 kg is associated with attribute information of an age of equal to or greater than 55 years old, a threshold of 5 kg is associated with attribute information of female, and a threshold of 7 kg is associated with other attribute information.

The delivery information includes thresholds varying depending on the weight and attribute of the package. The control part 23 of the delivery management server 2 reads, from the weight threshold information stored in the memory 22, the threshold of weight corresponding to the attribute information received by the communication part 21. The control part 23 generates delivery information including at least a package ID, weight information, and a threshold. The communication part 21 transmits, to the smartglasses 3, the delivery information including at least the package ID, the weight information, and the threshold. After determining that the motion state is the second motion state, the control part 32 may determine whether or not the weight included in the received delivery information is equal to or greater than the threshold included in the received delivery information.

Note that the memory 33 of the smartglasses 3 may store in advance weight threshold information in which the attribute information and the threshold of weight are associated with each other. In a case of determining that the motion state is the second motion state, the control part 32 may read the threshold corresponding to the attribute of the user from the weight threshold information stored in the memory 33.

In the present embodiment, the control part 32 of the smartglasses 3 may store the motion state having been determined in the memory 33, and the memory 33 may store the motion state determined by the control part 32. In a case where the motion state of the user transitions from the first motion state to the second motion state, since the user is in a state of about to hold the package, it is necessary to output alert information. On the other hand, in a case where the motion state of the user transitions from the third motion state to the second motion state, since the user is in a state of releasing the carried package, it is not necessary to output the alert information. Therefore, in a case of determining that the motion state is the second motion state, the control part 32 may acquire the motion state last time from the memory 33. Then, the control part 32 may generate the alert information in a case where the motion state last time is the first motion state, and needs not generate the alert information in a case where the motion state last time is the third motion state.

That is, after it is determined in step S6 of FIG. 4 that the motion state is the first motion state, the control part 32 may store, in the memory 33, the determined first motion state. After it is determined in step S10 of FIG. 4 that the motion state is the second motion state, the control part 32 may store, in the memory 33, the determined second motion state. After it is determined in step S11 of FIG. 4 that the motion state is the third motion state, the control part 32 may store, in the memory 33, the determined third motion state. Then, after storing the second motion state in the memory 33, the control part 32 may acquire the motion state last time from the memory 33. In a case where the motion state last time is the first motion state, the control part 32 may perform the process in and after step S12 in FIG. 5. In a case where the motion state last time is the third motion state, the control part 32 may proceed with the process to step S1.

In a case of determining that the motion state is the first motion state or the second motion state, the control part 32 may acquire the motion state last time from the memory 33. Then, in a case where the motion state last time is the third motion state and the alert information is output, the control part 32 may stop the output of the alert information.

In the present embodiment, the display part 35 displays the alert information, but the present disclosure is not particularly limited to this. The smartglasses 3 may include a speaker, and the control part 32 may output the alert information to the speaker. The speaker may voice-output the alert information.

In the present embodiment, the control part 32 may stop the output of the alert information in a case where a predetermined time has elapsed since the alert information is output.

Note that in each embodiment, each constituent element may include dedicated hardware or may be implemented by execution of a software program suitable for each constituent element. Each constituent element may be implemented by a program execution part, such as a CPU or a processor, reading and executing a software program recorded in a recording medium such as a hard disk or a semiconductor memory. The program may be carried out by another independent computer system by being recorded in a recording medium and transferred or by being transferred via a network.

Some or all functions of the devices according to the embodiment of the present disclosure are implemented as large scale integration (LSI), which is typically an integrated circuit. These may be individually integrated into one chip, or may be integrated into one chip so as to include some or all. Circuit integration is not limited to LSI, and may be implemented by a dedicated circuit or a general-purpose processor. A field programmable gate array (FPGA), which can be programmed after manufacturing of LSI, or a reconfigurable processor in which connection and setting of circuit cells inside LSI can be reconfigured may be used.

Some or all functions of the devices according to the embodiment of the present disclosure may be implemented by a processor such as a CPU executing a program. The numerical figures used above are all illustrated to specifically describe the present disclosure, and the present disclosure is not limited to the illustrated numerical figures.

The order in which each step shown in the above flowcharts is executed is for specifically describing the present disclosure, and may be any order other than the above order as long as a similar effect is obtained. Some of the above steps may be executed simultaneously (in parallel) with other steps.

The technique according to the present disclosure can reduce delivery errors and delivery loss and can improve delivery efficiency, and thus is useful as a technique for supporting a package carrying work by the user.

1. A wearable device worn on a head of a user, the wearable device comprising:
a camera;
a control part; and
a communication part,
wherein the camera photographs a user's visual field,
the control part
acquires an image photographed by the camera,
recognizes, through an image recognition process, a package and a hand of the user from the image having been acquired,
determines a motion state of the user with respect to the package based on a positional relationship between the package and the hand having been recognized, and
recognizes, through an image recognition process, a package ID for identifying the package from the image having been acquired,
the communication part
transmits, to a delivery management server, the package ID having been recognized and motion state information indicating the motion state having been determined, and
receives, from the delivery management server, delivery information regarding the package corresponding to the package ID and the motion state information, and
the control part
generates alert information to be presented to the user based on the delivery information having been received, and
outputs the alert information having been generated.

2. The wearable device according to claim 1, wherein
the motion state includes a first motion state in which the user is viewing the package at a place a predetermined distance away from the package, a second motion state immediately before the user holds the package, and a third motion state in which the user is carrying the package, and
the control part
determines that the motion state is the first motion state in a case of recognizing the package and not recognizing both hands of the user,
determines that the motion state is the second motion state in a case of recognizing at least one of a right hand and a left hand of the user, and when the right hand and the left hand of the user having been recognized are not positioned at a right end and a left end of the package having been recognized, and
determines that the motion state is the third motion state in a case of recognizing at least one of the right hand and the left hand of the user, and when the right hand and the left hand of the user having been recognized are positioned at a right end and a left end of the package having been recognized.

3. The wearable device according to claim 2, wherein
the package is placed on a shelf divided for each delivery area,
the delivery information includes a destination of the package, and
the control part recognizes, through an image recognition process, a delivery area corresponding to a shelf on which the package is placed from the image having been acquired in a case of determining that the motion state is the first motion state, and generates the alert information in a case where the destination included in the delivery information having been received is not included in the delivery area having been recognized.

4. The wearable device according to claim 2, wherein
the delivery information includes weight of the package or valuable article information indicating whether or not the package is a valuable article, and
the control part generates the alert information in a case of determining that the motion state is the second motion state, and the weight included in the delivery information having been received is equal to or greater than a threshold or the valuable article information included in the delivery information having been received indicates that the package is a valuable article.

5. The wearable device according to claim 4, wherein
the communication part transmits the package ID, the motion state information, and attribute information indicating an attribute of the user to the delivery management server, and
the delivery information includes the threshold varying depending on weight of the package and the attribute.

6. The wearable device according to claim 2, wherein
the delivery information includes weight of the package or valuable article information indicating whether or not the package is a valuable article, and
in a case of determining that the motion state is the second motion state,
the control part generates, as the alert information, a heat map representing, by a color in accordance with weight of the package, a part corresponding to the package having been recognized, or
generates, as the alert information, a heat map representing, by a color in accordance with whether or not the package is a valuable article, a part corresponding to the package having been recognized.

7. The wearable device according to claim 2, wherein
the delivery information includes redelivery information indicating whether or not redelivery has been requested for the package or absence information indicating whether or not a recipient of the package is absent on a scheduled delivery date of the package,
the delivery management server updates the redelivery information or the absence information for the package ID, and
the control part generates the alert information in a case of determining that the motion state is the third motion state, and when the redelivery information included in the delivery information having been received indicates that the redelivery has been requested or when the absence information included in the delivery information having been received indicates that the recipient is absent on the scheduled delivery date.

8. The wearable device according to claim 2, wherein
the wearable device further includes a memory that stores the motion state having been determined, and
the control part acquires the motion state last time from the memory in a case of determining that the motion state is the second motion state, generates the alert information in a case where the motion state last time is the first motion state, and does not generate the alert information in a case where the motion state last time is the third motion state.

9. The wearable device according to claim 2, wherein
the control part
recognizes, through an image recognition process, a package ID for identifying all packages included in the image having been acquired in a case of determining that the motion state is the first motion state, and
specifies one package that is a work target of the user, and recognizes, through an image recognition process, a package ID for identifying the one package having been specified from the image having been acquired in a case of determining that the motion state is the second motion state or the third motion state.

10. The wearable device according to claim 1, wherein
the wearable device further includes a display part,
the control part outputs the alert information to the display part, and
the display part displays, as augmented reality, the alert information in the user's visual field.

11. The wearable device according to claim 1, wherein
the wearable device further includes a speaker,
the control part outputs the alert information to the speaker, and
the speaker voice-outputs the alert information.

12. An information processing method in a wearable device worn on a head of a user, the information processing method comprising:
acquiring an image photographed by a camera that photographs a user's visual field;
recognizing, through an image recognition process, a package and a hand of the user from the image having been acquired;
determining a motion state of the user with respect to the package based on a positional relationship between the package and the hand having been recognized;
recognizing, through an image recognition process, a package ID for identifying the package from the image having been acquired;
transmitting, to a delivery management server, the package ID having been recognized and motion state information indicating the motion state having been determined;
receiving, from the delivery management server, delivery information regarding the package corresponding to the package ID and the motion state information;
generating alert information to be presented to the user based on the delivery information having been received; and
outputting the alert information having been generated.

13. A non-transitory computer readable recording medium storing an information processing program that causes a computer to function to:
acquire an image photographed by a camera that photographs a user's visual field;
recognize, through an image recognition process, a package and a hand of the user from the image having been acquired;
determine a motion state of the user with respect to the package based on a positional relationship between the package and the hand having been recognized;
recognize, through an image recognition process, a package ID for identifying the package from the image having been acquired;
transmit, to a delivery management server, the package ID having been recognized and motion state information indicating the motion state having been determined;
receive, from the delivery management server, delivery information regarding the package corresponding to the package ID and the motion state information;
generate alert information to be presented to the user based on the delivery information having been received; and
output the alert information having been generated.
